(19) United States
(12) Patent Application Publication
(10) Pub. No.: US 2015/0333454 A1
(43) Pub. Date: Nov. 19, 2015

(54) ADAPTOR CABLE FOR RETAIL DISPLAY OF ELECTRONIC DEVICE

(71) Applicant: Mobile Tech, Inc., Hillsboro, OR (US)

(72) Inventors: Donald Henson, Hillsboro, OR (US); Ron Peters, Hillsboro, OR (US); Eric Pitt, Hillsboro, OR (US); Khai Nguyen, Hillsboro, OR (US); Jack Li, Hillsboro, OR (US)

(73) Assignee: MOBILE TECH, INC., Hillsboro, OR (US)

(21) Appl. No.: 14/712,808

(22) Filed: May 14, 2015

Related U.S. Application Data
(60) Provisional application No. 61/993,533, filed on May 15, 2014.

(51) Int. Cl. H01R 13/66

(52) U.S. Cl. CPC H01R 13/665

(57) ABSTRACT

An adaptor cable for an electronic device offered for sale in a retail situation includes a connector adapted to connect the cable to the device. The connector houses a programmable chip that is capable of adjusting voltage and current levels to meet the requirements of the device.

### TECHNICAL FIELD

This disclosure relates to adaptor cables for powering electronic devices (smart phones, tablets, and similar hand-helds) at display positions in retail stores or similar locations where hand-helds are offered for sale to consumers. More particularly, this disclosure relates to adaptor cables that adjust power (voltage and amperage) from a power source to the voltage and amperage requirements of a specific hand-held.

### BACKGROUND OF THE INVENTION

Electronic hand-helds are commonly displayed at retail “post” positions. While the post position may take various physical forms, it usually involves an array of products on a counter or wall display that offers the consumer the option of lifting the product and examining it during the course of shopping.

It is common to tether the hand-held to the display via either a mechanical tether (i.e., a braided metal cable) or a multi-conductor tether (i.e., a tether with conductor wires in it). The tether is usually connected to a mounting member (sometimes called a “puck” in the industry). The puck usually serves as a supporting platform for the hand-held, when the hand-held sits on the display surface (the puck is often cradled or supported on a base or a short post).

Power is supplied to the hand-held from a power module that is essentially a generic power source. A power adaptor cable then connects the device to the puck.

Power is commonly delivered to the puck, first, at a certain voltage and amperage level that is elevated and capable of providing sufficient power to a range of devices (each having different power requirements). However, the input power is also at a higher level that is out of specification relative to the operating voltage and current of specific devices. In other words, power to the puck may be supplied at a range from three to 28 volts, with peak amperages up to 4 amps (these are examples only), whereas the device operates at lower voltage and amperage levels. Therefore, power from the puck needs to be adjusted to run the device.

In order to adjust voltage and amperage to meet the needs of the device, dedicated resisters have been built into adaptor cables to adjust source power to the level needed by the device. The problem with this design is that the resistor makes each adaptor cable specific to not only the power requirements of the device but it is also married to the input levels received from the power source. Because the resistors are built into the adaptor cable, this arrangement makes it difficult to reuse adaptor cables as devices are swapped to and from displays.

### SUMMARY

An adaptor cable interconnects a mounting puck to a hand-held device. The adaptor cable includes a connector fitting that connects a programmable device to the puck, preferably by a female jack on the puck.

The programmable device converts input power from the puck to the voltage and amperage levels that meet the specifications of the device. The programmable device may be reprogrammed or reset so that the same adaptor cable can be used to connect different hand-helds (having different power requirements) to the same puck, using the same adaptor cable.

While the programmable device may be carried or housed within a connector fitting, it is also possible to locate the programmable device elsewhere in the cable. In other words, the programmable device may be carried by the adaptor cable in a connector fitting, on one end or the other, or carried at some other location along the length of the adaptor cable, so long as the programmable device is capable of converting input power to the desired output power level required by the specific hand-held.

The above features will become more clearly understood upon review of the following description, which is to be taken in conjunction with the accompanying drawings.

### BRIEF DESCRIPTION OF THE DRAWINGS

In the drawings, like reference numerals and letters refer to like parts throughout the various views, and wherein:

FIG. 1 is a pictorial view of an electronic hand-held device with a mounting member or “puck” exploded from the device, with an adaptor cable connecting the device to the puck;

FIG. 2 is a view like FIG. 1, but shows the mounting member attached to the hand-held;

FIG. 3 is a pictorial view of an adaptor cable design;

FIG. 4 is a view like FIG. 3, but is taken from a different angle;

FIG. 5 is a pictorial view of one-half of a housing on the end of the adaptor cable shown in FIGS. 3-4;

FIG. 6 is a view like FIG. 5, but shows the other one-half of the housing;

FIG. 7 is a pictorial view of a connector portion of the cable shown in FIGS. 3-4;

FIG. 8 is a pictorial view of a programmable chip; and

FIG. 9 is a schematic showing the functional operation of the programmable chip shown in FIG. 8.

### DETAILED DESCRIPTION

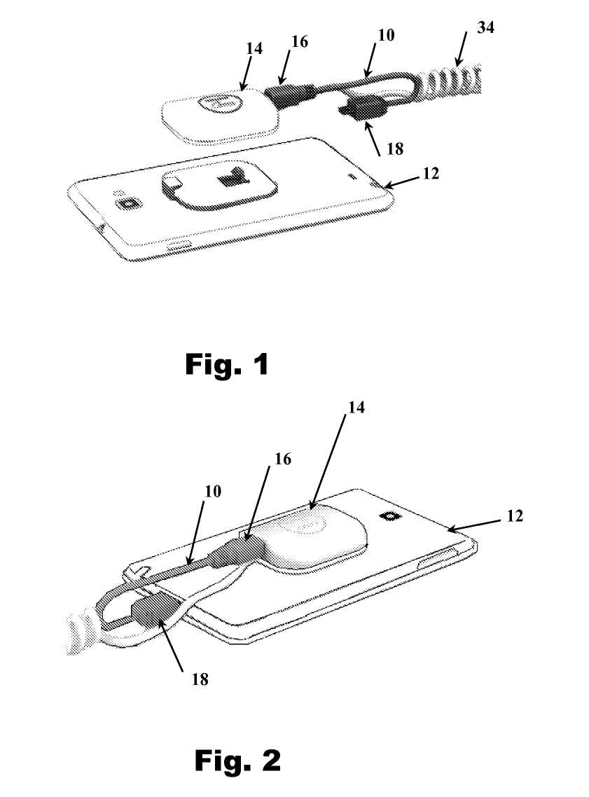

Referring now to the drawings, and first to FIG. 1, shown generally at 10 is an improved cable assembly for electrically coupling a hand-held device 12 to a mounting member or puck 14. One end 16 of the cable assembly 10 is shown connected to the puck 14. The other end 18 of the cable assembly 10 has a connector fitting that is plugged into a female jack fitting on the hand-held 12. The shape of the connector fitting 18 may be unique to the hand-held manufacturer.

In accordance with the design disclosed here, one or the other connector fittings 16, 18 are adapted to carry a chip, the operational characteristics of which are further described below. However, and as just mentioned, connector fitting 18 can be unique to the female jack provided by the hand-held manufacturer. Therefore, it is anticipated that the chip may best be housed in the other fitting 16 (i.e., connected to the puck 14).

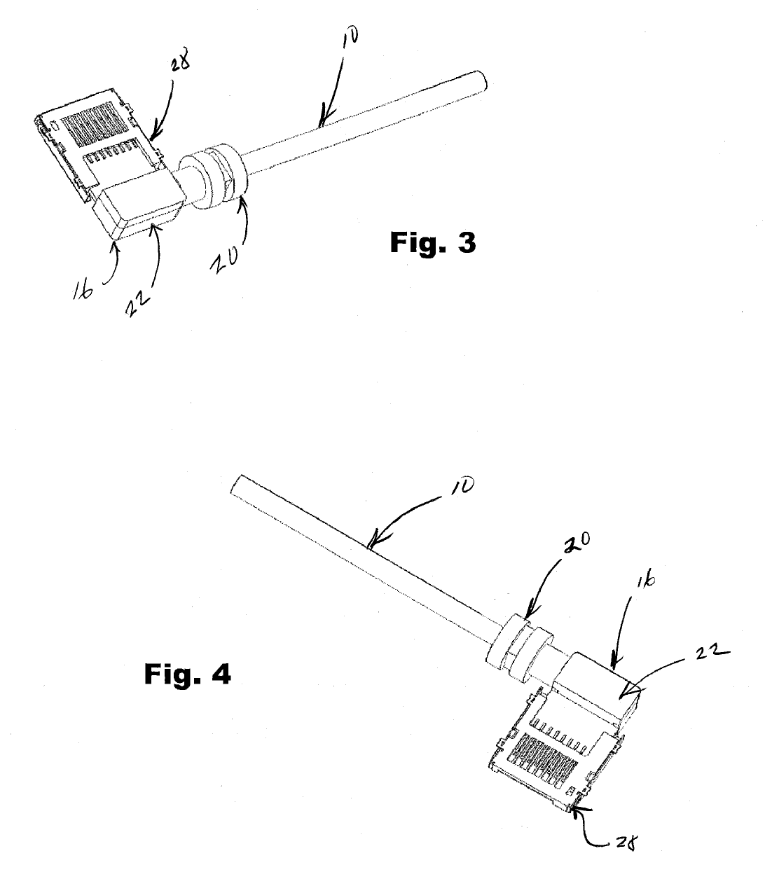

Referring now to FIG. 3, reference numeral 16 illustrates in greater detail, how connector fitting 16 can be modified to carry a programmable chip. As in FIGS. 1-2, the cable assembly is generally indicated at 10 in FIGS. 3 and 4. On the end of the cable 10 is a strain-relief fitting, generally indicated at 20. The fitting 20 provides a means for relieving stresses that are put on the connector 16 when a consumer examines the hand-held 12. As discussed above, consumer examination of the hand-held 12 often involves lifting the hand-held from the display position. This action stresses connection points on cabling.

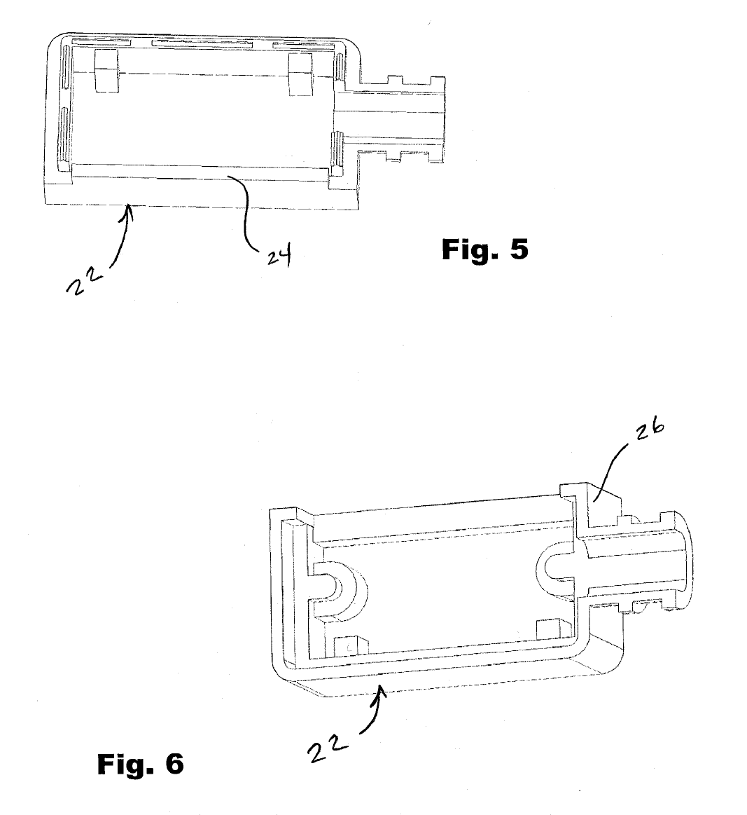

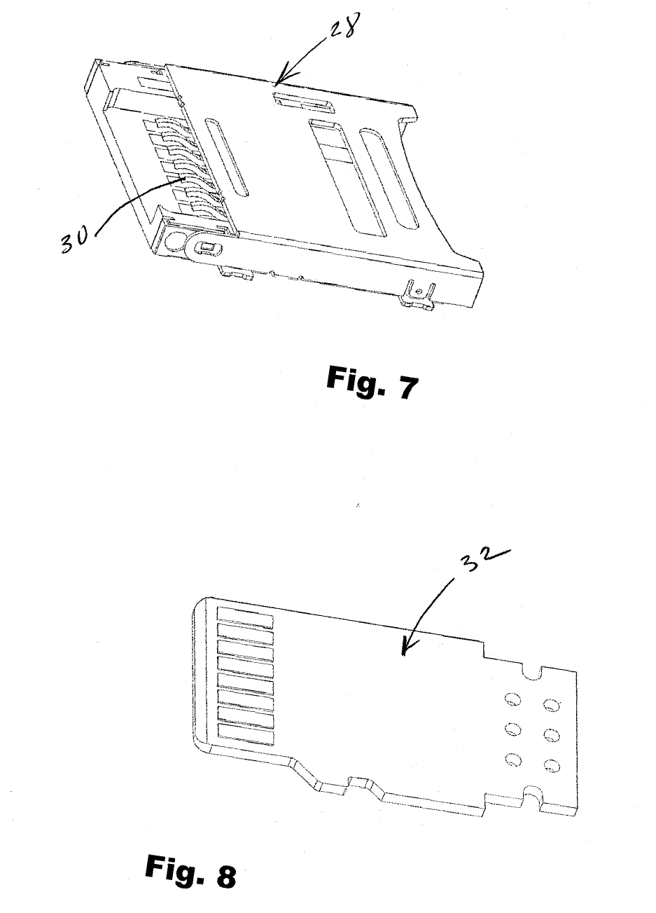

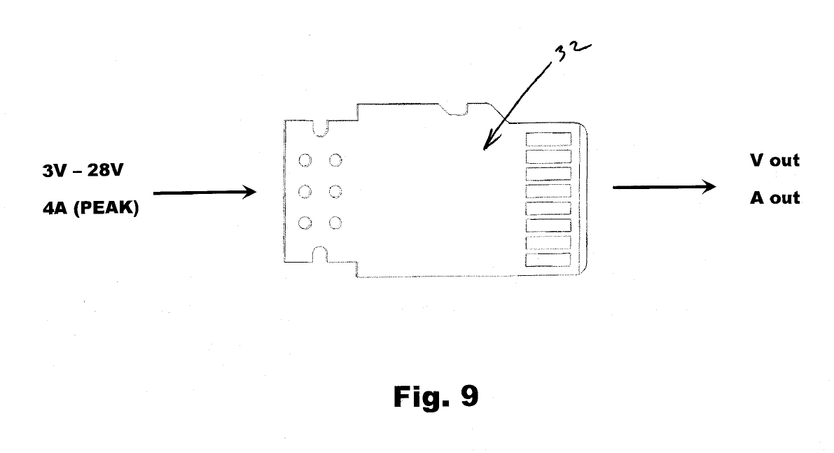

A fitting housing, generally indicated at 22, is located on the end of the cable assembly 10. FIGS. 5 and 6 show upper and lower halves 24, 26 of the fitting housing 22. Projecting from the fitting housing 22 is a Molex-type connector 28 that has connector elements (indicated generally by 30 in FIG. 7). Wiring from the cable 10 goes to the connector 28 in conventional fashion. The housing 22 and connector 28 also captures a chip, indicated generally at 32 in FIG. 8, which is electrically coupled to puck 14 via connector 28. The connector 28 plugs into the puck 14 which has a corresponding female jack.

The chip 32 is of a type that is capable of adjusting incoming power (delivered first to the puck 14 and then output to the adaptor cable 10) to the requirements needed by the hand-held 12, in lieu of the resistor method described above. Returning again to FIG. 1, this FIG. shows the puck 14 exploded from the hand-held 12. FIG. 2 shows the same embodiment, but with the puck 14 mounted to the hand-held 12. Power to the puck 14 may be supplied in different ways.

In the embodiment shown in FIGS. 1-2, power may be supplied via a separate power cable 34 that delivers input power at a certain voltage and amperage level to the puck 14. While not shown here, the puck 14 may contain an internal electronics control board (“ECB”) that provides retail security or other functions. Some power from cable 34 may be used to power such functions. Other power is to be passed through to drive a hand-held 12 and/or charge the hand-held's battery.

In preferred form, incoming power to the puck 14, could be in the range of 3 to 28V, with 3 amps continuous, up to 4 amps of peak power. Within this input range, a means must be provided to adjust these voltage and amperage levels to the requirements that are unique or specific to the hand-held 12, as provided by the adaptor cable 10.

The chip 32 in the fitting 16 is a programmable device that can receive elevated voltage and amperage and adjust incoming values to device voltage and current required as per device specifications. Moreover, the chip 32 can be easily reprogrammed so that the same cable assembly 10 can be used to power a different hand-held having different voltage and amperage input requirements. Chips of this type can also adapt to variations in power input (i.e., power supplied to the puck 14 or otherwise provided at the jack connection point (for connector 16, in this example).

In the near-term implementation, the chip 32 is programmed at the factory for setting the output voltage and current to the level needed to match the intended device's requirements. However, it could be reprogrammed on-site, to match a different device. Electronically programmable chips of the type described here are well-known and could be easily adapted to the above functionality.

As indicated, the above design allows the same cable assembly to be used or reused multiple times as devices change, rather than undergo the expense of purchasing new adaptor cables. Moreover, by providing the retailer with a simple add-on at the store, in the form of a stand-alone programming device or a downloadable app for an existing device to do the programming, the retailer can easily undertake reprogramming at the store.

Concerning the above, it is possible to develop a small, hand-held programming tool or device that enables programming individual cables, either at the factories or for store technicians to use. The programming device will include an LED display for data and/or a simple button keypad for inputting make and model of the hand-held, as well as the applicable power numbers. The programming device will be capable of reading existing cable settings and displaying them. Other programming information may be displayed such as, for example, device type, brand, model number, operating voltage, etc.

At the customer (retailer) level, the programming device will be simplified for customer use (i.e., a store employee). As one possible embodiment, it is conceivable that the customer's device will support a mobile app that can be loaded into the operating system of a smart phone, as an example. In other words, it may be possible to develop an app that a store employee can download to his or her local phone from the factory website for the purpose of reprogramming adaptor cables. Other features may be included such as Bluetooth compatibility. The app interface would include simple, drop-down menus that allow the store user to easily set-up a programming profile for the adaptor cable. In this way, unprogrammed adaptor cables could be plugged into a local programming module (e.g., local smart phone or other programming device) that encode the applicable programming instructions to the chip inside the cable assembly. As indicated above, this would allow the store to program and reprogram cable assemblies, thus saving substantial costs relating to the purchase of new cable assemblies as devices change, with one key limitation being the use of proprietary input jacks.

The implementation of a chip in the adaptor cable provides advantages that relate to monitoring of the device's operation, so that power can be used more efficiently (energy savings). The chip offers a “smart” platform for performing other functions such as transmitting to outside peripherals data concerning the specific kind of device that is merchandised at specific display post positions. It is conceivable the chip could be made to communicate with the device or puck to handle other power supply and/or diagnostic functions.

The above description is not intended to be limiting. The spirit and scope of patent protection is to be limited only by the patent claim or claims that follow, the interpretation of which is to be made in accordance with the established doctrine of patent claim interpretation.

What is claimed is:

1. An adaptor cable for supplying power to an electronic device, comprising:
a cable electrically carrying a programmable device, said programmable device being operable to adjust an input voltage and amperage to a desired power output level that meets the voltage and amperage of the electronic device.

2. The adaptor cable of claim 1, wherein the cable includes a connector for electrically connecting the cable to the electronic device, and wherein the connector houses the programmable device.

3. The adaptor cable of claim 1, including means for programming the programmable device, to change the power output to meet the voltage and amperage requirements of another electronic device.
